(19) United States
(12) Patent Application Publication
(10) Pub. No.: US 2026/0013613 A1
(43) Pub. Date: Jan. 15, 2026

(54) Luggage Device with Integrated Weighing System

(71) Applicant: Dominic McDonald, Nassau (BS)

(72) Inventor: Dominic McDonald, Nassau (BS)

(21) Appl. No.: 19/261,202

(22) Filed: Jul. 7, 2025

Related U.S. Application Data
(60) Provisional application No. 63/669,710, filed on Jul. 11, 2024.

(51) Int. Cl. A45C 13/28; G01G 19/58; G01G 21/00

(52) U.S. Cl. CPC A45C 13/28; G01G 19/58; G01G 21/00; A45C 2200/05

(57) ABSTRACT

A luggage device with integrated weighing system is provided. The device is comprised of a luggage body with two impact-resistant shells joined by a zipper. The body also includes multidirectional wheels with optional shock-absorbing suspension, a telescopic handle, and additional carry handles for versatility. The interior of the body incorporates a weighing system with embedded load cells that measure luggage weight and display the results on a digital screen, with an audio alert system to help users manage airline weight restrictions by alerting them to the weight inside the body. The device may also feature an automatic zipper mechanism with touch-sensitive buttons controlling the zipper operation through a track-guided lever system.

### CROSS-REFERENCE TO RELATED APPLICATION

The present application claims priority to, and the benefit of, U.S. Provisional Application No. 63/669,710, which was filed on Jul. 11, 2024, and is incorporated herein by reference in its entirety.

### FIELD OF THE INVENTION

The present invention relates generally to the field of luggage. More specifically, the present invention relates to a piece of luggage with an integrated internal weighing system that measures and displays luggage weight while providing audio alerts related to the amount of weight present. The device may also include an automatic zipper mechanism with touch-sensitive buttons controlling the zipper operation through a track-guided lever system. Accordingly, the present disclosure makes specific reference thereto. Nonetheless, it is to be appreciated that aspects of the present invention are also equally applicable to other like applications, devices, and methods of manufacture.

### BACKGROUND

When traveling by airplane, luggage weight is a crucial factor in determining baggage fees, often leading to unexpected costs for travelers. Many individuals are unaware that their suitcase exceeds the weight limit until they arrive at the airport, which can result in last-minute repacking at the check-in counter. This process is inconvenient and may lead to the removal of essential items or the need for additional baggage fees. Furthermore, attempting to gauge luggage weight by lifting it can be difficult and may cause physical strain or injury, particularly for individuals with limited strength or mobility. Traditional luggage designs do not provide a built-in method for determining weight, requiring travelers to rely on external weighing devices or estimation, both of which can be unreliable. Additionally, the need to repeatedly unzip, rearrange, and repack a suitcase at the airport can be time-consuming and stressful. Current luggage options also lack automation features that could simplify the packing and security process.

Therefore, there exists a long-felt need in the art for a luggage device with an integrated weighing system that provides travelers with real-time weight measurement to prevent overweight baggage fees. There also exists a long-felt need in the art for a luggage device with an integrated weighing system that eliminates the need for travelers to physically lift their luggage to estimate its weight. Moreover, there exists a long-felt need in the art for a luggage device with an integrated weighing system that features an automated zipper mechanism to enhance convenience and reduce the effort required for packing and unpacking.

The subject matter disclosed and claimed herein, in one embodiment thereof, comprises a luggage device with integrated weighing system. The device is comprised of a luggage body with two impact-resistant shells joined by a zipper. The body also includes multidirectional wheels with optional shock-absorbing suspension, a telescopic handle, and additional carry handles for versatility. The interior of the body incorporates a weighing system with embedded load cells that measure luggage weight and display the results on a digital screen, with an audio alert system to help users manage airline weight restrictions by alerting them to the weight inside the body. The device may also feature an automatic zipper mechanism with touch-sensitive buttons controlling the zipper operation through a track-guided lever system.

In this manner, the luggage device with integrated weighing system of the present invention accomplishes all the foregoing objectives and provides a piece of a luggage that provides real-time weight readings directly to a digital display to ensure that travelers can accurately determine whether their luggage is within airline weight limits before arriving at the airport, preventing unexpected fees and reducing the need for repacking. Additionally, the built-in weighing system eliminates the need for travelers to manually lift their luggage to estimate its weight, thereby reducing strain and minimizing the risk of injury. The inclusion of an automated zipper system further enhances convenience by allowing users to open and close their suitcase with the touch of a button, streamlining the packing process and improving overall usability. Through these features, the device significantly improves the travel experience by providing a more efficient, user-friendly, and stress-free luggage solution.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a luggage device with integrated weighing system. The luggage device is an improved piece of luggage incorporating an integrated weighing system and an automated zipper system. The device comprises a body with two halves, a top shell, and a bottom shell, connected by at least one zipper. The device is also comprised of at least one multidirectional wheel. The body also features at least one handle, including a telescopic handle with a push-button locking mechanism, a rubberized or textured grip, and an ergonomic contour for comfort. Additional carry handles also provide alternative carrying options.

The interior of the device includes a built-in weighing system with at least one load cell embedded beneath a weight plate in both shells. The load cells measure the total weight of packed items and relay the data to a digital display. A speaker emits audio alerts when the suitcase approaches or exceeds airline weight limits.

The zipper system may be manual or automatic, with touch-sensitive control buttons for opening and closing. Each button is associated with a zipper lever positioned along a track that enables movement. The buttons feature icon-based indicators for visual guidance and may be illuminated. Actuation of the buttons moves the zipper levers to open or close the main compartment.

Accordingly, the luggage device with integrated weighing system of the present invention is particularly advantageous as it provides a piece of a luggage that provides real-time weight readings directly to a digital display to ensure that travelers can accurately determine whether their luggage is within airline weight limits before arriving at the airport, preventing unexpected fees and reducing the need for repacking. Additionally, the built-in weighing system eliminates the need for travelers to manually lift their luggage to estimate its weight, thereby reducing strain and minimizing the risk of injury. The inclusion of an automated zipper system further enhances convenience by allowing users to open and close their suitcase with the touch of a button, streamlining the packing process and improving overall usability. Through these features, the device significantly improves the travel experience by providing a more efficient, user-friendly, and stress-free luggage solution. In this manner, the luggage device with integrated weighing system overcomes the limitations of existing luggage known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a luggage device with integrated weighing system of the present invention while closed in accordance with the disclosed architecture;

FIG. 2 illustrates a side cross-sectional view of one potential embodiment of a luggage device with integrated weighing system of the present invention while open in accordance with the disclosed architecture;

FIG. 3 illustrates a perspective view of one potential embodiment of a luggage device with integrated weighing system of the present invention while closed in accordance with the disclosed architecture; and

FIG. 4 illustrates a perspective view of one potential embodiment of a luggage device with integrated weighing system of the present invention while open in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof.

It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a luggage device with an integrated weighing system that provides travelers with real-time weight measurement to prevent overweight baggage fees. There also exists a long-felt need in the art for a luggage device with an integrated weighing system that eliminates the need for travelers to physically lift their luggage to estimate its weight. Moreover, there exists a long-felt need in the art for a luggage device with an integrated weighing system that features an automated zipper mechanism to enhance convenience and reduce the effort required for packing and unpacking.

The present invention, in one exemplary embodiment, is comprised of a luggage device with integrated weighing system. The device is comprised of an enhanced piece of luggage incorporating a built-in weighing system and an automated zipper system. It comprises a body with two halves, a top shell, and a bottom shell, connected by at least one zipper. At least one multidirectional wheel is also included. The body further features at least one handle, including a telescopic handle with a push-button locking mechanism, a rubberized or textured grip, and an ergonomic contour for comfort. Additional carry handles provide alternative carrying options.

The interior includes a weighing system with at least one load cell embedded beneath a weight plate in both shells. The load cells measure the total weight of packed items and relay the data to a digital display. A speaker emits audio alerts when the suitcase approaches or exceeds airline weight limits.

The zipper system may be manual or automatic, with touch-sensitive control buttons for opening and closing. Each button is linked to a zipper lever positioned along a track that enables movement. The buttons include icon-based indicators for visual guidance and may be illuminated. Actuation of the buttons moves the zipper levers to open or close the main compartment.

As a result, the luggage device with an integrated weighing system offers significant advantages by providing real-time weight readings on a digital display, enabling travelers to determine if their luggage meets airline weight restrictions before arriving at the airport, thereby preventing unexpected fees and reducing the need for repacking. The built-in weighing system eliminates the need for travelers to manually lift their luggage to estimate its weight, reducing strain and minimizing the risk of injury. The automated zipper system further enhances convenience by allowing users to open and close the suitcase with the touch of a button, streamlining the packing process and improving usability. Through these features, the device enhances the travel experience by providing a more efficient, user-friendly, and stress-free luggage solution, addressing the limitations of conventional luggage.

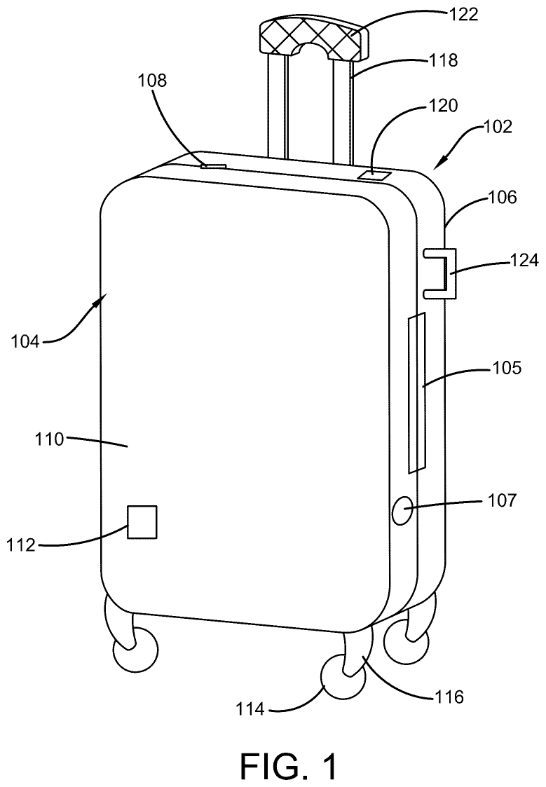

Referring initially to the drawings, FIG. 1 illustrates a front perspective view of one potential embodiment of a luggage device with integrated weighing system 100 of the present invention while closed in accordance with the disclosed architecture. The luggage device with an integrated weighing system 100 provides an improved piece of luggage with an integrated weighing system 140 and an automated zipper system 108.

The device 100 is comprised of a body 102 with two attached halves, a top shell 104 and a bottom shell 106, which are securely joined by at least one zipper 108 and at least one hinge 105. In one embodiment, the hinge 105 is a motorized hinge that allows the shells 104,106 to separate/lift via at least one button 107. The shells 104, 106 are preferably constructed from impact-resistant polycarbonate, aluminum alloy, or a hybrid combination of both to enhance structural resilience. The exterior surface 110 of the halves 104, 106 may feature a textured, scratch-resistant coating 112 to minimize visible wear from frequent use and handling.

The device 100 is also comprised of at least one wheel 114 (as seen in FIG. 1) that is preferably a 360-degree multidirectional (relative to a vertical axis of the wheel 114) wheel. In one embodiment, the wheel 114 is comprised of a shock-absorbing suspension system 116 that minimizes vibrations and reduces impact forces when rolling over uneven terrain, preventing excessive strain on both the wheels 114 and the luggage structure.

The body 102 is further comprised of at least one handle 118, as seen in FIG. 1. In one embodiment, the handle 118 is comprised of a motorized, telescopic handle that extends and retracts via a push-button mechanism 120 (or other manual or automatic/motorized mechanism), which locks securely at multiple height settings to accommodate users of different statures. The handle 118 may be comprised of a grip area 122 that may be made from a rubberized or textured material to improve grip, preventing slippage during transport. The handle 118 may also include an ergonomic contour to provide comfort during extended use. The device 100 may also be comprised of additional carry handles 124 to provide alternative carrying options, allowing travelers to lift and transport the suitcase when necessary.

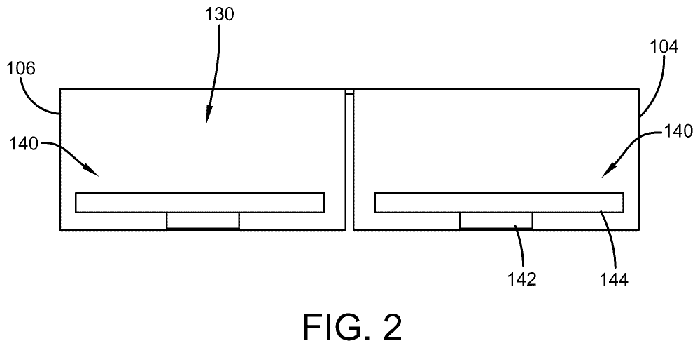

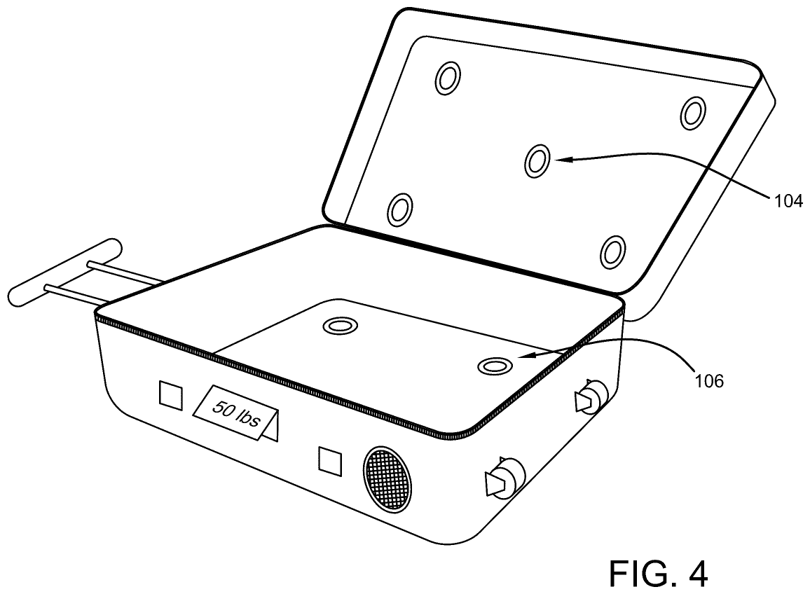

The interior space 130 of the body 102 is comprised of a built-in weighing system 140, as seen in FIG. 2 and FIG. 4. The system 140 is comprised of at least one load cell 142, such as, but not limited to, compression load cells or strain gauge load cells, embedded beneath a weight plate 144 positioned in both the top and bottom shells 104, 106. During use, the load cells 142 detect the cumulative weight of packed items resting atop the plates 144 (in addition to the weight of the entire device 100 when empty) and relay the measurement to a digital display 146.

The weighing system 140 includes a speaker 148 that emits an audio alert to help users manage airline weight restrictions. More specifically, the speaker 148 emits a series of beeping alerts when the suitcase weight reaches a first designated weight (such as, but not limited to, 45 pounds), serving as an early warning. If the weight then exceeds a second weight (such as, but not limited to, 50 pounds), a continuous beep sounds, notifying the user that the luggage has surpassed the standard airline weight limit. This enables travelers to make real-time packing adjustments, reducing the likelihood of overweight baggage fees or last-minute repacking at the airport. The device 100 is powered by a rechargeable battery 150 that can be charged via a charging port 152, such as, but not limited to, a USB-C or micro-USB port.

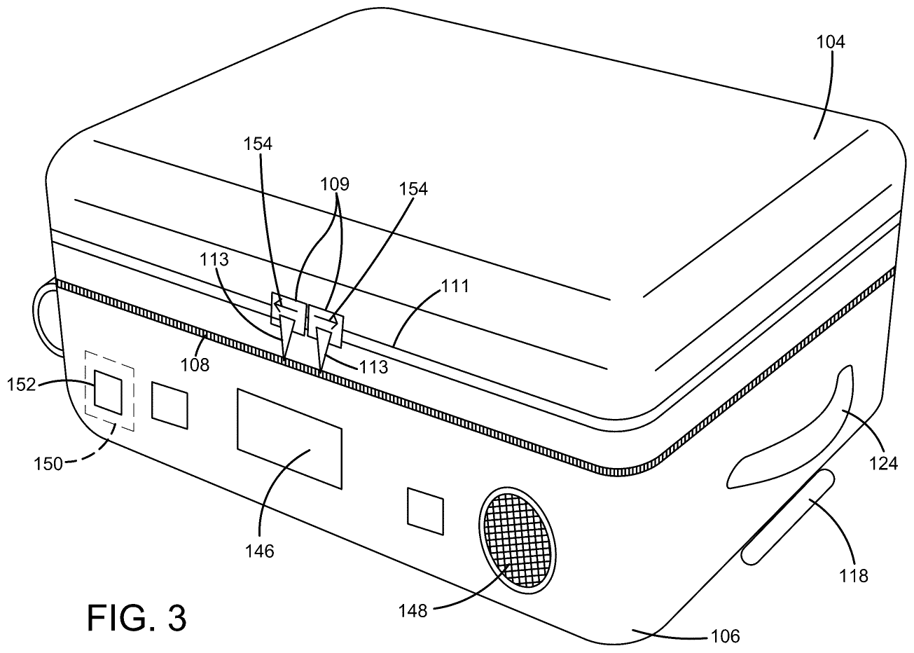

In one embodiment, the zipper 108 is a manual zipper. In another embodiment, the zipper 108 may additionally or alternatively be an automatic zipper that can be opened and closed using at least one touch-sensitive control button 109, as seen in FIG. 3. By way of example, a first button 109 of a first color initiates the opening sequence of the zipper 108, while a second button 109 of a second color activates the closing mechanism, drawing the zipper 108 back together to secure the suitcase. Each button 109 is further associated with a respective zipper lever 113. The buttons 109 may be mechanically or electronically coupled to the zipper levers 113, wherein the levers 113 may be positioned along a track 111 that runs parallel to the zipper 108. The track 111 allows the buttons 109 to slide freely along the zipper 108 while the zipper levers 113 open and close the zipper 108.

Each button 109 may incorporate an icon-based indicator 154 as seen in FIG. 3, such as an open arrow displayed in green and a closed arrow displayed in red, providing a clear visual representation of zipper operation. The icon-based indicator 154 may be illuminated or non-illuminated, depending on design preference, and may be printed, embossed, or displayed via an LED screen integrated into the button 109. The track 111 is configured to provide smooth, low-friction movement, allowing the buttons 109 to slide with minimal resistance. During operation, actuation of the first button 109 causes the corresponding zipper lever 113 to move in a first direction, opening the main compartment of the luggage. Actuation of the second button 109 causes the zipper lever 113 to move in the opposite direction, closing the main compartment. The buttons 109 may be spring-loaded or electronically reset to return to their starting position upon deactivation, ensuring proper alignment for subsequent use.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “luggage device with integrated weighing system” and “device” are interchangeable and refer to the luggage device with integrated weighing system 100 of the present invention.

Notwithstanding the foregoing, the luggage device with integrated weighing system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the luggage device with integrated weighing system 100 as shown in the FIGS. are for illustrative purposes only, and that many other sizes and shapes of the luggage device with integrated weighing system 100 are well within the scope of the present disclosure. Although the dimensions of the luggage device with integrated weighing system 100 are important design parameters for user convenience, the luggage device with integrated weighing system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A luggage device with integrated weighing system comprising:
a body comprising a top shell and a bottom shell joined by a zipper;
a wheel coupled to the body;
a handle attached to the body;
a weighing system comprising:
a first load cell positioned beneath a first weight plate in the top shell and a second load cell positioned beneath a second weight plate in the bottom shell; and
a digital display configured to display a weight measurement based on data received from the first load cell and the second load cell.

2. The luggage device with integrated weighing system of claim 1, wherein the first load cell and the second load cell are comprised of a compression load cell or a strain gauge load cell.

3. The luggage device with integrated weighing system of claim 1 further comprised of a battery.

4. The luggage device with integrated weighing system of claim 3, wherein the battery is comprised of a charging port.

5. The luggage device with integrated weighing system of claim 1, wherein the handle is comprised of a telescopic handle.

6. The luggage device with integrated weighing system of claim 1 further comprised of a carry handle.

7. A luggage device with integrated weighing system comprising:
a body comprising a top shell and a bottom shell joined by a zipper;
a wheel coupled to the body;
a handle attached to the body;
a weighing system comprising:
a first load cell positioned beneath a first weight plate in the top shell and a second load cell positioned beneath a second weight plate in the bottom shell;
a digital display configured to display a weight measurement based on data received from the first load cell and the second load cell; and
a speaker configured to emit an audio alert when a detected weight reaches a first designated threshold and a continuous audio alert when the detected weight exceeds a second designated threshold.

8. The luggage device with integrated weighing system of claim 7, wherein the body is comprised of a scratch-resistant coating.

9. The luggage device with integrated weighing system of claim 7, wherein the wheel is comprised of a shock-absorbing suspension system.

10. The luggage device with integrated weighing system of claim 7, wherein the handle is comprised of a telescopic handle.

11. The luggage device with integrated weighing system of claim 10, wherein the telescopic handle can be extended and retraction via a push button mechanism.

12. The luggage device with integrated weighing system of claim 10 further comprised of a battery.

13. A luggage device with integrated weighing system comprising:
a body comprising a top shell and a bottom shell joined by an automatic zipper;
a wheel coupled to the body;
a handle attached to the body;
a weighing system comprising:
a first load cell positioned beneath a first weight plate in the top shell and a second load cell positioned beneath a second weight plate in the bottom shell;
a digital display configured to display a weight measurement based on data received from the first load cell and the second load cell; and
a speaker configured to emit an audio alert when a detected weight reaches a first designated threshold and a continuous audio alert when the detected weight exceeds a second designated threshold.

14. The luggage device with integrated weighing system of claim 13, wherein the automatic zipper can be opened or closed via a control button.

15. The luggage device with integrated weighing system of claim 14 further comprised of a track.

16. The luggage device with integrated weighing system of claim 15 further comprised of a zipper lever positioned along the track.

17. The luggage device with integrated weighing system of claim 16, wherein the zipper level is coupled to the control button.

18. The luggage device with integrated weighing system of claim 14, wherein the control button is comprised of an icon-based indicator.

19. The luggage device with integrated weighing system of claim 13 further comprised of a battery.

20. The luggage device with integrated weighing system of claim 14, wherein the control button is comprised of a touch-sensitive button.
